(19) United States
(12) Patent Application Publication
(10) Pub. No.: US 2013/0312264 A1
(43) Pub. Date: Nov. 28, 2013

(54) Illuminated Waterproof Safety Razor

(71) Applicant: Deborah S. Cohen, Northbrook, IL (US)

(72) Inventor: Deborah S. Cohen, Northbrook, IL (US)

(21) Appl. No.: 13/479,672

(22) Filed: May 24, 2012

(51) Int. Cl. B26B 21/46

(52) U.S. Cl. 30/34.05

(57) ABSTRACT

A safety razor for illuminating the area of skin to be shaved having a substantially translucent or transparent handle, the handle including one or more light emitting elements, such as an LED, and a power source electrically and selectively connected to the light emitting elements. A neck portion is permanently attached to the handle, and includes one or more light emitting elements electrically and selectively connected to the power source. A razor blade is permanently attached to the handle, or a razor cartridge connection portion is permanently attached to the neck portion. The cartridge connection portion removably attaches a razor cartridge to the handle in one embodiment. An end cap removably attached to the handle opposite the neck portion includes a seal for providing a waterproof seal between the end cap and the handle. An actuator selectively activates the light emitting elements.

### BACKGROUND OF THE INVENTION

1. Field of the Invention

The present invention relates to an illuminated, waterproof, safety razor constructed to provide lighting means to illuminate the area of skin ahead of the blade, the area beneath and to the side of the handle, and a portion of the skin behind the blade.

2. Description of the Prior Art

Illuminated safety razors are well known. Men's and women's razors usually comprise at least a handle and a razor blade or cartridge connected to the handle. Women shave parts of the body that are curved and sometimes difficult to reach and see, and they typically shave in poorly lit areas, such as the shower. Men shave parts of the body that are also curved and difficult to see due to poor lighting in a bathroom or shower and/or being some distance away from a minor. This often results in nicks and cuts to the skin, and residual patches of skin still containing hair, which were missed during the shaving process. The illuminated safety razors of the prior art do not have translucent or transparent handles and do not illuminate the area of skin ahead of the blade, along with the area of skin to the side of and beneath the handle, and a portion of the area of skin behind the blade.

U.S. Pat. No. 6,915,576 discloses an illuminated safety razor comprising a transparent handle and a razor head adapted to hold a razor blade cartridge. An LED disposed in the razor head illuminates a small area to be shaved. The handle, open at the end opposite the razor head, is adapted to receive at least one battery. The threaded end cap, comprising a waterproof diaphragm cover, contains a micro-pushbutton switch. Depressing the waterproof diaphragm covering the rear of the end cap toggles the switch, supplying voltage to the LED and illuminating the small area to be shaved. The '576 patent discloses a high intensity LED disposed in the razor head, however, it does not provide for an elevated mounting or multiple LEDs or other light sources illuminating the area of the skin behind the razor head, or a wide area adjacent the razor handle.

U.S. Patent Publication 2008/0134511 discloses a safety razor comprising a handle and a light energy device adapted to provide a beneficial effect to the skin of a user of the safety razor during a shaving operation. The '511 specification and claims call for specific light wavelengths, to achieve a specific beneficial effect, such as hair removal, acne treatment, anti-aging effects, and reduction of scarring and wound healing. This patent publication is not directed towards illuminating the skin to aid in shaving.

U.S. Patent Publication 2008/0028616 discloses a shaver with a lighting means, wherein the head portion is formed with a shape of a vehicle front portion so that light is irradiated from a lighting means. The lighting lamp of the '616 patent publication is in the headlights of the vehicle-shaped head, placing them slightly elevated from the razor. Although the lighting lamp is slightly elevated in the shaver head, this is the only lighting location. The handle is not translucent or transparent and does not have LEDs, or other light sources, located therein.

The prior art to date does not disclose the combination of an illuminated safety razor comprising a translucent or transparent handle, a neck portion, a cartridge connection portion, a razor cartridge or razor blade, and a switch. At least one light device is elevated above the razor blade or cartridge on the neck portion and at least one light energy device is disposed inside the handle. The power source is also disposed inside the handle and is held in place by a waterproof end cap. None of the prior art can be combined in this way to suggest these necessary modifications. There is no teaching, suggestion, or motivation that would have enabled a person of ordinary skill in the art to modify any prior art illuminated safety razors to provide for elevated light emitting devices, i.e. LED, mounting and wide, multiple skin area illumination.

It is a primary object of the present invention to provide a safety razor with illumination to the area of skin to be shaved ahead of the blade, beneath and along the side of the handle, and a portion of the skin behind the blade to provide safety, convenience, and a clean shave to the user.

It is another primary object of the present invention to provide an aesthetic and ergonomic apparatus with which to safely shave.

### SUMMARY OF THE INVENTION

The waterproof, safety razor of the present invention is adapted to illuminate the area to be shaved and a wide surrounding area. The safety razor comprises a handle having a razor blade either attached to the neck of the handle or a cartridge connection permitting a cartridge to be removably connected to the neck of the handle, allowing the user to attach any razor cartridge of his/her liking and replace the cartridges as needed. The illuminated area of the skin includes at least the area ahead of the blade, to the sides of the handle, beneath the handle, and a portion of the skin behind the blade. An illustrated embodiment of the present invention comprises: a substantially transparent or translucent handle, a neck portion, a cartridge connection portion, an end cap, a power source, at least one light emitting element, a permanent or replaceable razor cartridge, and a switch and any combination thereof.

In a first embodiment, the handle is substantially transparent or translucent and has a cavity adapted to hold a control circuit for a light energy device, at least one light emitting element, and a power source, such as battery. The light emitting elements are positioned throughout the body of the handle and in the neck portion with the neck portion light element located close to and slightly elevated from the razor head portion of the body near and above where the cartridge or blade is attached. The razor cartridge is coupled to the cartridge connection portion and may be any cartridge on the market. The light emitting elements can be clear or can be different colors and are powered by the power source. The switch can be a micro-pushbutton switch located on the end cap or on the side of the handle. The end cap forms a waterproof seal with the handle.

In a second embodiment, the handle is substantially translucent, hollow, and includes a plurality of first transparent portions. The neck portion is substantially translucent, hollow, and includes at least one second transparent portion. The light emitting element and the power source are located in the end cap, which forms a waterproof seal with the handle.

### BRIEF DESCRIPTION OF THE DRAWINGS

The present invention is further described with reference to the accompanying drawings in which:

FIG. 1 is a schematic view of a first embodiment of the illuminated, waterproof, safety razor of the present invention.

FIG. 2 is a schematic view of a second, alternate embodiment of the illuminated, waterproof, safety razor of the present invention.

### DETAILED DESCRIPTION OF THE ILLUSTRATED EMBODIMENTS

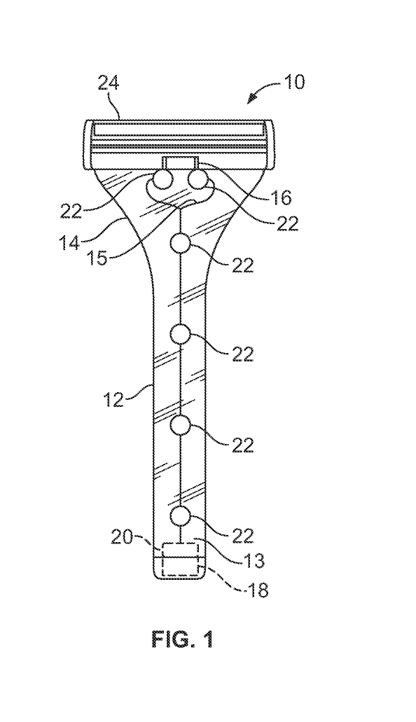

Referring to FIG. 1, a first illustrated embodiment of the illuminated, waterproof, safety razor 10 of the present invention comprises a handle 12, a neck portion 14, a cartridge connection portion 16, an end cap 18, a power source 20, at least one light emitting element 22, a razor blade or cartridge 24, and a switch (not shown). The handle 12 is at least substantially translucent, if not transparent. The handle 12 has a first cavity 13 adapted to hold a control circuit (not shown), at least one light emitting element 22, and a power source 20. The light emitting element 22 can be any light source, such as a light emitting diode (LED). The first cavity 13 in the handle 12 is adapted to hold a plurality of light emitting elements 22 in an embodiment.

The handle 12 is in communication with the neck portion 14, and they are typically molded together. The neck portion also has a second cavity 15 adapted to hold at least one light emitting element 22. The light emitting elements 22 in the neck portion 14 are situated close to, and slightly elevated from, the cartridge connection portion 16 of the illuminated safety razor 10, near and above the razor blade or cartridge 24. The light emitting elements 22 can be clear or can be of any different color.

The neck portion 14 is in communication with the cartridge connection portion 16. The cartridge connection portion 16 is in removable communication with the razor cartridge 24, as is known in the art. When the razor cartridge 24 becomes dull and needs to be replaced, the user releases the razor cartridge 24 from the cartridge connection portion 16 and attaches a new razor cartridge 24. The razor cartridge 24 can be any cartridge sold on the market. Alternatively, the razor blade or cartridge 24 would be permanently molded onto the handle and thus not be replaceable, making the illuminated safety razor 10 disposable.

The light emitting elements 22 are powered by a power source 20, such as a battery. The power source 20 is located at the end of the handle 12 opposite the neck portion 14, between the end cap 18 and the light emitting elements 22. The power source 20 can also be located inside the end cap 18 itself. The power source 20 can be rechargeable, in which the illuminated safety razor 10 could be plugged in to a source of electricity to recharge the power source 20. The power source 20 can also be replaceable, in which batteries can be used and replaced once power runs out. The end of handle 12 opposite the neck portion 14 is removably engageable with the end cap 18, which seals the contents in cavity 13 within the handle 12. The end cap 18 is equipped with a rubber or otherwise pliable and waterproof material that forms a waterproof seal when the end cap 18 is engaged with the end of the handle 12 opposite the neck portion 14. The switch (not shown) can be any kind of switch, such as micro-pushbutton pressure switch, and can be located on the end cap 18 or the side of the handle 12. Actuation of the switch turns the light emitting elements 22 on and off. Alternatively, the switch can be a motion actuated switch in a timer circuit, which turns the light emitting elements 22 on when a user lifts the illuminated, waterproof safety razor 10.

The illuminated, waterproof safety razor 10 can also come equipped with a timer. Once the light emitting elements 22 are turned on, a timer starts and keeps the light emitting elements 22 on for a predetermined period of time, such as ten to thirty minutes. Upon expiration of the designated time, the light emitting elements 22 would automatically turn off.

The illuminated, waterproof safety razor 10 can be sold with a holding case. The holding case can be used for storage and can be attached to the shower wall. In the case of a rechargeable power source 20, the holding case can be used to recharge the razor 10. The holding case plugs into an electrical outlet and upon placing the razor 10 in the holding case, the power source 20 would be recharged.

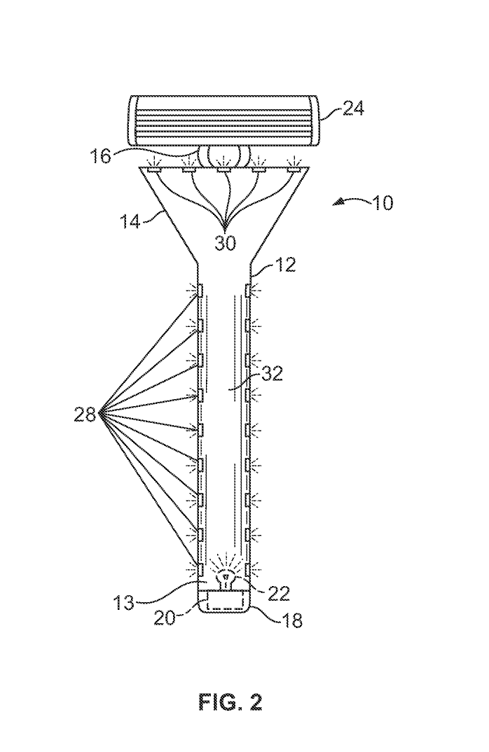

In an alternate embodiment, shown in FIG. 2, where like numerals designate like parts in FIG. 1, the illuminated, waterproof safety razor 10 incorporates a light pipe configuration. In this embodiment, the light emitting element 22 is located in the end cap 18, which also contains the power source 20. The end cap 18 is engageable with the end of handle 12 opposite the neck portion 14, forming a waterproof seal. In the embodiment of FIG. 2, the handle 12 is made of a transparent or translucent plastic material that is light transmissive, or preferably highly light transmissive. The outer surface of the handle 12 is coated with an opaque, non-light transmissive coating 32, except for designated areas 28 and 30, where it is desired that light from light emitting element 22 be allowed to be transmitted to the skin areas of the user. The transparent or translucent handle 12 provides a light tube to direct illumination from light emitting element 22, through the handle 12, until the light reaches the areas 28, 30, at which areas the light is transmitted out of handle 12 and onto the skin of the user of the razor 10. The at least one second transparent portion 30 is situated close to, and slightly elevated from, the cartridge connection portion 16, emitting light above the razor cartridge 24. The light emitted from the first and second transparent portions 28, 30 illuminates the area to be shaved and its surrounding area.

To begin use, the user picks up the illuminated, waterproof, safety razor 10 and checks if there is a razor cartridge 24 attached. If there is no razor cartridge 24 attached, the user selects a razor cartridge 24 of their choice that is sold on the market and attaches it to the cartridge connection portion 16 of the razor 10. The user then locates the switch, on the end cap 18 or the side of the handle 12, and pushes the switch to the “on” position. If a motion actuated switch is used, the user simply lifts the razor 10 to turn on the light emitting elements 22. The light emitting elements 22 are turned on and illuminate the area of skin ahead of the blade, behind the blade, and beneath and to the side of the handle 12 and blade. The user can then safely shave the illuminated skin, making sure that no area of skin is left unshaved. Once shaving is completed, the user pushes the switch to the “off” position and stores the razor 10 in the holding case until the next use.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification and it will be understood that various modifications may be made without departing from the spirit and scope of the invention.

What is claimed is:

1. A safety razor for illuminating the area of skin to be shaved, comprising:
a. a safety razor having a handle that attaches to one of a razor blade and removable razor cartridge;
b. a substantially translucent or transparent handle, said handle including at least one light emitting element, a control circuit, and a power source electrically and selectively connected to said at least one light emitting element;
c. a neck portion attached to said handle, said neck portion including at least one light emitting element electrically and selectively connected to said power source;
d. an end cap removably attached to said handle opposite said neck portion, said end cap including a seal for providing a waterproof seal between said end cap and said handle; and
e. an actuator selectively activating said at least one light emitting element, said actuator permanently attached to one of said handle and said end cap.

2. The safety razor of claim 1, wherein the safety razor includes a cartridge connection portion permanently attached to said neck portion.

3. The safety razor of claim 2, wherein the cartridge connection portion is adapted to removably attach a razor cartridge to the handle.

4. The safety razor of claim 1, wherein the razor blade is permanently attached to the neck portion.

5. The safety razor of claim 1, wherein the at least one light emitting element comprises a plurality of light emitting elements of the same or differing colors.

6. The safety razor of claim 1, wherein the at least one light emitting element is a light emitting diode (LED).

7. The safety razor of claim 1, wherein the actuator is a micro-pushbutton switch, said switch being activated when pressed.

8. The safety razor of claim 1, wherein the actuator is a motion-actuated switch, said switch being activated by lifting said razor.

9. The safety razor of claim 1, wherein the power source is a battery.

10. The safety razor of claim 1, wherein the power source is rechargeable.

11. The safety razor of claim 1, wherein the seal comprises a waterproof gasket located between said end cap and said handle.

12. The safety razor device of claim 1, wherein the at least one light emitting element included on said neck portion is positioned close to and slightly elevated from said razor blade or cartridge.

13. The safety razor of claim 1, wherein the at least one light emitting element comprises a plurality of light emitting elements extending in a spaced relation along the length of the handle.

14. The safety razor of claim 1, wherein the razor includes a holding case, said case adapted to be removably attached to a shower wall.

15. The safety razor of claim 1, wherein the razor includes a holding case, said case including a connector adapted to receive a power source charger.

16. The safety razor of claim 1, wherein the razor includes a timer, said timer turning off the at least one light emitting element upon expiration of a predetermined time period.

17. A safety razor for illuminating the area of skin to be shaved, comprising:
a. a safety razor having a handle attached to one of a razor blade and a removable razor cartridge, the handle being substantially translucent, said handle including a plurality of transparent surface areas along the length of said handle, the handle including opaque surface areas disposed between said transparent surface areas;
b. a neck portion permanently attached to said handle, said neck portion including at least one transparent surface area along an end of said neck portion;
c. an end cap removably attached to said handle opposite said neck portion, said end cap including a seal for providing a waterproof seal between said end cap and said handle, said end cap also including at least one light emitting element and a power source electrically and selectively connected to said at least one light emitting element; and
d. an actuator selectively actuating said at least one light emitting element, said actuator permanently attached to one of said handle and said end cap.

18. The safety razor of claim 17, wherein the safety razor includes a cartridge connection portion permanently attached to said neck portion.

19. The safety razor of claim 18, wherein the cartridge connection portion is adapted to removably attach a razor cartridge to the handle.

20. The safety razor of claim 17, wherein the razor blade is permanently attached to the neck portion.

21. The safety razor of claim 17, wherein the at least one light emitting element is a light emitting diode (LED).

22. The safety razor of claim 17, wherein said light emitting element is located at an end of said handle opposite said neck portion, the light generated by said light emitting element being directed through said handle, said light being cast from said handle through said transparent surface areas when said light emitting element is activated.

23. The safety razor of claim 17, wherein the seal comprises a waterproof gasket located between said end cap and said handle.

24. The safety razor of claim 17, wherein the safety razor includes a holding case, said holding case adapted to be removably attached to a shower wall.

25. The safety razor of claim 17, wherein the safety razor includes a holding case, said holding case including a connector adapted to receive a power source charger.

26. The safety razor of claim 17, wherein the razor includes a timer, said timer turning off the at least one light emitting element upon expiration of a predetermined time period.
